(19) United States
(12) Patent Application Publication
(10) Pub. No.: US 2011/0288931 A1
(43) Pub. Date: Nov. 24, 2011

(54) MICROSITE MODELS

(75) Inventors: Christina Kuhn, Mountain View, CA (US); Ravi Jain, Palo Alto, CA (US)

(73) Assignee: GOOGLE INC., Mountain View, CA (US)

(21) Appl. No.: 12/784,443

(22) Filed: May 20, 2010

(51) Int. Cl. G06Q 30/00; G06F 17/30

(52) U.S. Cl. 705/14.49; 707/709; 707/723; 707/726; 707/E17.108

(57) ABSTRACT

This specification describes technologies relating to content presentation. In general, one aspect of the subject matter described in this specification can be embodied in methods that include the actions of generating a directed graph of a mobile application, each node of the directed graph corresponding to an annotated page view of the mobile application; converting, using one or more processors, the directed graph into a microsite of the mobile application; crawling the microsite to identify keywords for the mobile application; and using the identified keywords to identify candidate advertisements to present to users of the mobile application. Other embodiments of this aspect include corresponding systems, apparatus, and computer program products.

### BACKGROUND

The present disclosure relates to content presentation.

Advertisers provide advertisements in different forms in order to attract consumers. An advertisement (“ad”) is a piece of information designed to be used in whole or part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a webpage or a mobile application, as an impression. An advertising system can include an ad in a webpage, for example, in response to one or more keywords in a user search query input to a search engine. If a user selects the presented ad (e.g., by “clicking” the ad), the user is generally taken to another location associated with the ad, for example, to another, particular web page.

### SUMMARY

This specification describes technologies relating to content presentation.

In general, one aspect of the subject matter described in this specification can be embodied in methods that include the actions of generating a directed graph of a mobile application, each node of the directed graph corresponding to an annotated page view of the mobile application; converting, using one or more processors, the directed graph into a microsite of the mobile application; crawling the microsite to identify keywords for the mobile application; and using the identified keywords to identify candidate advertisements to present to users of the mobile application. Other embodiments of this aspect include corresponding systems, apparatus, and computer program products.

These and other embodiments can optionally include one or more of the following features. Generating the directed graph further includes generating a screenshot for each page view of the mobile application; extracting text from each screenshot; and using the extracted text to annotate the page view. Generating screenshots includes initiating the mobile application; capturing a screenshot of the starting page of the mobile application; systematically providing input to the mobile application to identify possible responses from the mobile application; and generating a separate screenshot for each response from the mobile application. Converting the directed graph into a microsite further includes converting each node of the graph into a page of the microsite; and converting each edge of the graph into a link to a related page of the microsite. The extracted keywords are assigned a weight according to a relative importance of the page view in the mobile application. The relative importance is determined based on the number of directed edges in the graph pointing to the node corresponding to the page view. The directed graph includes obtaining a channel ID for each page view and including the channel ID in the annotation for the page view.

In general, one aspect of the subject matter described in this specification can be embodied in methods that include the actions of receiving a request for an ad, the request including an application identifier; using the application identifier to identify a corresponding microsite; using keywords generated for the microsite to identify candidate ads; selecting one or more ads of the candidate ads; and providing the selected ads for presentation by the mobile application. Other embodiments of this aspect include corresponding systems, apparatus, and computer program products.

These and other embodiments can optionally include one or more of the following features. Selecting one or more ads includes ranking the candidate ads according to a score, the score depending on a weight given to particular keywords extracted from the microsite. Receiving the request includes receiving a channel ID associated with the page view of the mobile application to present the requested ad, the method further includes identifying the particular portion of the microsite associated with the received channel ID; and using the keywords from the particular portion to identify the candidate ads.

Particular embodiments of the subject matter described in this specification can be implemented to realize one or more of the following advantages. A microsite model can be generated for a mobile application so that advertisements can be targeted to mobile applications to improve or replace targeting from existing mobile application context (e.g., application publisher provided keywords). Keywords can be identified for mobile applications for which source code or application text is not available to augment or replace keywords provided by the publisher or other application context. Relevant advertising can be provided in response to requests for advertising content initiated by mobile applications. Microsite models can result in accurate ad targeting which can improve ad performance (e.g., higher click through and conversion rates for advertisements presented as part of mobile applications.

The details of one or more embodiments are set forth in the accompanying drawings and the description below. Other features and advantages will be apparent from the description and drawings, and from the claims.

### BRIEF DESCRIPTION OF DRAWINGS

FIG. 1 is a diagram of an example content presentation system.

FIG. 2 is a block diagram of an example system including a mobile device application.

FIG. 3 is a block diagram of an example system for generating microsites and using the microsites to provide ads to mobile applications.

FIG. 4 is a flow chart of an example method for generating a microsite model.

FIG. 5 is a flow chart of an example method for systematically obtaining pages from a mobile application.

FIG. 6 is a flowchart of an example method for serving ads to a mobile application.

Like reference symbols in the various drawings indicate like elements.

### DETAILED DESCRIPTION

Context can be obtained for targeting content items (e.g., ads) to mobile applications using generated microsites. As used in the present specification, a “microsite” refers to a site (e.g., a website) that has a form similar to that of a conventional website, but is not intended for public consumption, instead, the microsite represents a site only available internally for targeting content items. Mobile applications can be analyzed to generate a directed graph of mobile application page content. Each node of the directed graph can be annotated to include text extracted from the corresponding page content. The directed graph can be converted into a corresponding microsite for the mobile application. The microsite can be crawled to identify one or more keywords associated with the mobile application. The keywords can be used to target ads to users of the mobile application.

While reference will be made below to advertising systems and methods, other forms of content including other forms of sponsored content can be managed, presented, and tracked in accordance with the description below.

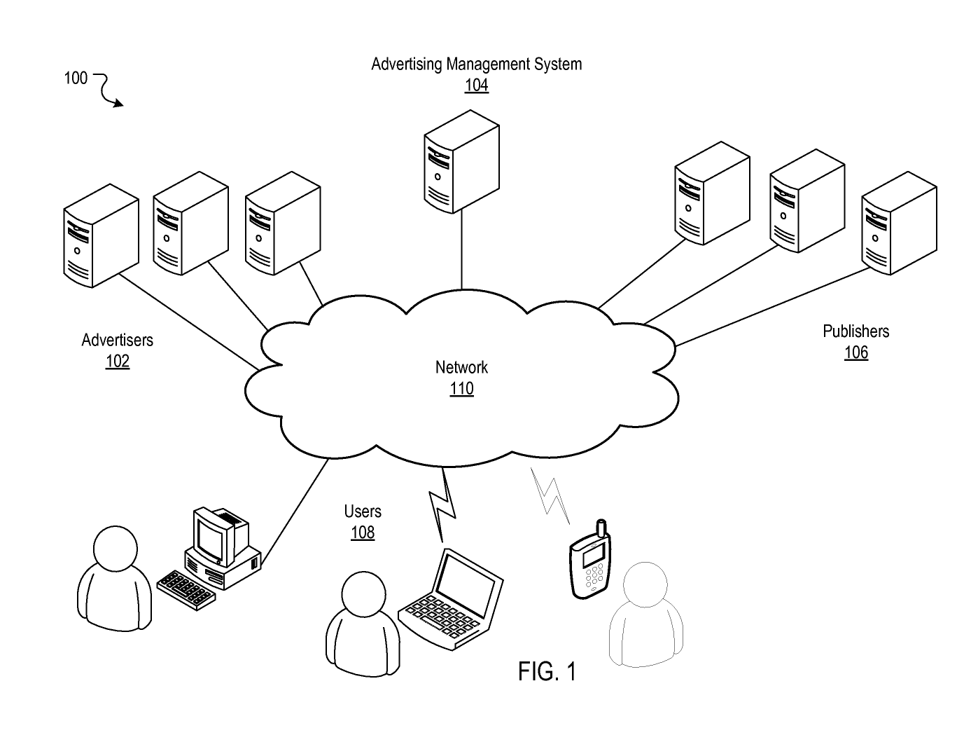

FIG. 1 is a block diagram of an example content presentation system 100. In some implementations, one or more advertisers 102 can directly, or indirectly, enter, maintain, and track ad information in an advertising management system 104. Though reference is made to advertising, other forms of content, including other forms of sponsored content, can be delivered by the system 100. The ads can be in the form of graphical ads, such as banner ads, text only ads, image ads, barcode ads (e.g., an ad that includes one or more barcodes), audio ads, video ads, animated ads, ads combining one or more of any of such components, etc. The ads can also include embedded information, such as links, meta-information, and/or machine executable instructions. One or more publishers 106 may submit requests for ads to the system 104. The system 104 responds by sending ads to the requesting publisher 106 for placement on or association with one or more of the publisher's content items (e.g., web properties). Example web properties can include web pages, television and radio advertising slots, or print media space.

Other entities, such as users 108 and the advertisers 102, can provide usage information to the system 104, such as, for example, whether or not a conversion (e.g., a purchase or other interaction) or a click-through related to an ad (e.g., a user has selected an ad) has occurred. This usage information can include measured or observed user behavior related to ads that have been served. The system 104 may perform financial transactions, for example, crediting the publishers 106 and charging the advertisers 102 based on the usage information.

A network 110, such as a local area network (LAN), wide area network (WAN), the Internet, one or more telephony networks or a combination thereof, connects the advertisers 102, the system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for ads to an advertisement server in the system 104. The ad request can include a number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser combines the requested content with one or more of the ads provided by the system 104. The combined content and ads can be sent/rendered to the users 108 that requested the content for presentation in a viewer (e.g., a browser or other content display system). The content server can transmit information about the ads back to the advertisement server, including information describing how, when, and/or where the ads are to be rendered (e.g., in HTML or JavaScript™).

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and may be grouped into a predetermined number of (e.g., ten) search results.

The search service can submit a request for ads to the system 104. The request may include a number of ads desired. This number can depend, for example, on the search results, the amount of screen or page space occupied by the search results, the size and shape of the ads, etc. The request for ads may also include the query (as entered or parsed), information based on the query (such as geo-location information, whether the query came from an affiliate and an identifier of such an affiliate), and/or information associated with, or based on, the search results. Such information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores are computed from, for example, dot products of feature vectors corresponding to a query and a document, page rank scores, and/or combinations of IR scores and page rank scores, etc.

In some implementations, the advertisement management system 104 can use an auction process to select ads from the advertisers 102. For example, the advertisers 102 may be permitted to select, or bid, an amount the advertisers are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the system 104. This combined information can then be forwarded to the users 108 that requested the content. The search results can be maintained as distinct from the ads, so as not to confuse the user between paid ads and presumably neutral search results.

In some implementations, one or more publishers 106 submit requests for ads to the advertising management system 104. The system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system can provide sports-related ads to the publisher 106. In some implementations, the requests can instead be executed by devices associated with the user 108, e.g., by the execution of a particular script (e.g., javascript) when the publisher's web page is loading on a client device.

Another example publisher 106 is a mobile application developer. A mobile application is an application specifically designed for operation on a mobile device (e.g., a smart phone). The mobile application can also include ads positioned within the content of the mobile application. Similar to publishers 106 described above, the ads can be received from the system 104 for placement in the mobile application when accessed by a user (e.g., when a particular page of a mobile application is loaded on the mobile device).

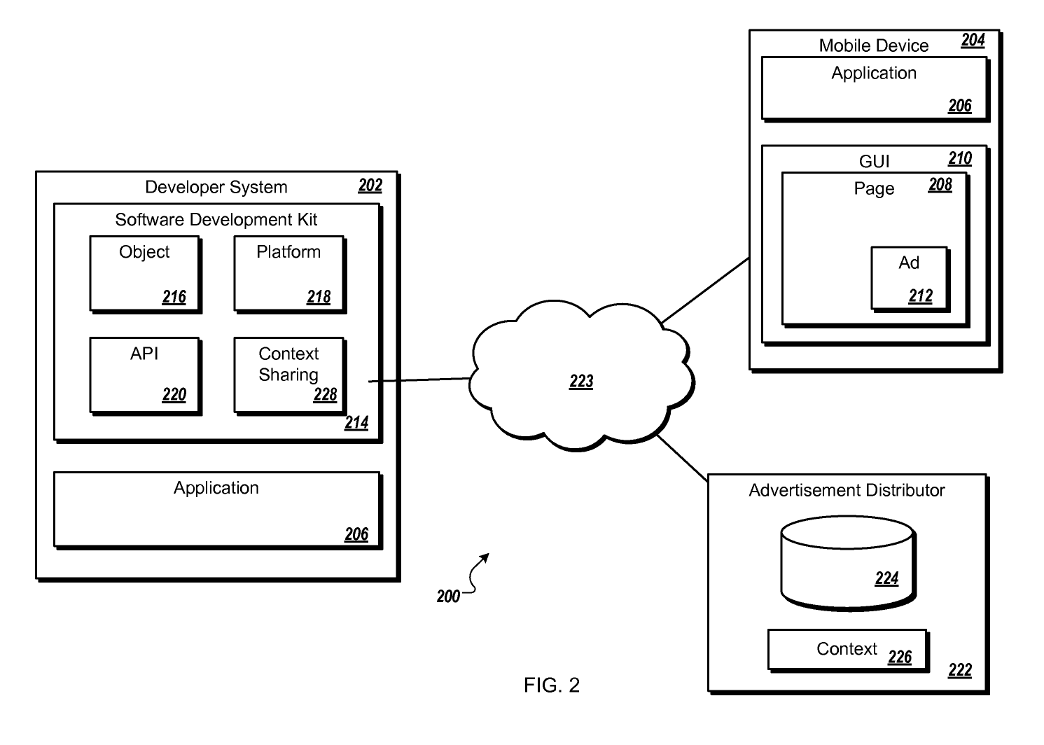

FIG. 2 shows an example of a system 200 including an application for a mobile device. In this example, a developer system 202 can be used by a developer to create program content such as applications for one or more mobile devices 204, such as a cellular telephone, a personal digital assistant or any other type of mobile device. Particularly, the developer can create an application 206 such as by generating program code and compiling it into an executable program compatible with the mobile device 204.

The application 206 can be formulated so that it presents one or more pages 208 in a graphical user interface 210 of the mobile device 204, such as on a display screen. Individual systems and/or components can be implemented using hardware, firmware, software, or combinations thereof, and can be divided or joined into different number of units. Examples below will illustrate how the developer can configure the application 206 so that content 212, such as an advertisement from a third party, can be presented on the page(s) 208 when the application 206 is being executed.

A software development kit 214 can be provided to the developer for creating the application 206 and/or other programs. The software development kit 214 can provide editors for code and/or pseudocode, one or more compiling functions, emulating functions for previewing display content, and a debugging function, to name just a few examples. In some implementations, the software development kit 214 can also be configured to provide the developer a convenient way of adding third-party content such as advertisements to a program created for mobile devices. For example, the software development kit 214 can provide the developer with the necessary code and/or other application content so that advertisements are requested, displayed to a user, and that any interaction between the user and the ad is tracked.

The software development kit 214 can provide one or more objects 216. In some implementations, the developer can incorporate the object 216 in the code when creating the application. For example, the software development kit 214 can provide the object(s) 216 on a screen, such as where the developer generates the overall application content, in a way that the developer can select the object and include the corresponding material in the application as it is being created.

The software development kit can be configured so that the application(s) 206 can be created according to a particular platform 218. In some implementations, the platform 218 can be targeted to mobile devices, such as to the type of the mobile device 204 which can include a cell phone, handheld device, personal digital assistant, to name just a few examples. For example, the platform 218 can be a platform created or supported by the Open Handset Alliance. In some implementations, the object 216 is included before the application code is compiled into an executable program. For example, the object can be incorporated as an integrated part of the application by inserting code before compilation.

The object 216 can perform one or more functions. In some implementations, the object can cause third party content such as the advertisement(s) 212, to appear on the mobile device 204. For example, the object 216 can be responsible for requesting relevant ad(s), displaying the ad(s) in the right manner to the user, and tracking whether the user clicks on the ad or otherwise interacts with the ad.

In some implementations, the object 216 is a Java object that is configured to be added to a user interface of the application 206 and handle fetching and rendering of, and interaction with, content such as advertisements. For example, the developer can implement a view object that extends a view class associated with the application 206.

An application program interface (API) 220 can be used with the object 216. In some implementations, the API is a Java API that a developer can call when incorporating content such as advertisements into the application 206. For example, the object 216 can include a Java code snippet that uses the Java API 220 so that the developer can insert the code into the application 206. As noted earlier, such a code snippet can construct a request for content such as an ad based on a developer's customization, fetch the content and write it to the user interface of the application 206.

The ad 212 can include various types of content. In some implementations, ad types including, but not limited to, text ads, image ads (such as animated GIFs and/or Flash-based images) and video ads can be used. For example, the ad can provide for user navigation (e.g., a link) to other content associated with the advertiser. Other types of content are possible (e.g., non-advertising content).

An advertisement distributor system 222 can be used to forward content such as the ad 212 to the mobile device 204 and/or the developer system 202. In some implementations, the advertisement distributor system 222 is configured to receive request(s) for content from the mobile device 204, fetch one or more matching ads or other content from a repository 224, and forward the matching content to the mobile device. For example, the matching of the ad 212 can be performed using a context component 226, which can provide one or more context parameters associated with the application 206 configured for identifying matching content/advertisements.

The developer system 202, the mobile device 204 and/or the advertisement distributor system 222 can be connected using any kind of network 223, such as the Internet. For example, the developer system 202 and the advertisement distributor system 222 can communicate using the TCP/IP suite of protocols and the mobile device 204 can communicate using any kind of wireless protocol, such as IEEE 802.11, WAP and/or Bluetooth.

Relevant context of the application 206 and/or the mobile device 204 can be shared in different ways. In some implementations, the developer can share context including metadata about the application 206 with the advertisement distributor system 222. A context sharing component 228 in the software development kit 214 can allow the developer to enter one or more keywords that the developer decides are relevant for retrieving and presenting content such as advertisements. For example, the developer who creates the application can submit the keyword(s) using the context sharing component 228 for receipt by the context component 226 for storage. In some implementations, monitoring can be performed to determine how well the submitted metadata correlates with the application 206 and if necessary, modifications in the used context parameter(s) can be made.

In some implementations, context can be shared by the developer submitting the application 206 to the advertisement distributor system 222. The context sharing component 228 can be used in submitting some or all of the application 206 for use in evaluating context. This can be done as part of a setup process so that the advertisement distributor system 222 can examine the application to determine the context of the content/ads to be forwarded. Examples of aspects that can be taken into account include, but are not limited to, textual content of a previous screen or page on the mobile device 204, a content of the entire application 206, and/or content of other view objects such as sibling objects. Analysis of the application 206 can include analyzing the code (such as by static analysis), determining a general context of the application 206, or determining the specific context of one or more of the particular pages 208. This can require the context component 226 to determine which of the pages 208 is currently active in the mobile device 204. For example, this can be done using a version of the application 206 provided by the developer. If or when the application 206 is later updated, a revised version can be forwarded to the advertisement distributor system 222, for example using the context sharing component 228, so that the context can be updated if necessary.

As another example, context can be determined by providing that the developer can specify one or more hooks in the code of the application 206. In some implementations, the software development kit 214 and/or the platform 218 can provide such feature(s). For example, a global variable can be made to change state at one or more stages of the application 206. Such a variable can be read by the object 216, such as by a snippet of Java code.

Context parameter(s) for use in finding matching content such as advertisements can be stored in any of a variety of forms. For example, the context component 226 can store one or more keywords, categories, labels, topics, context information and/or any other kind of parameter for use by the advertisement distributor system 222.

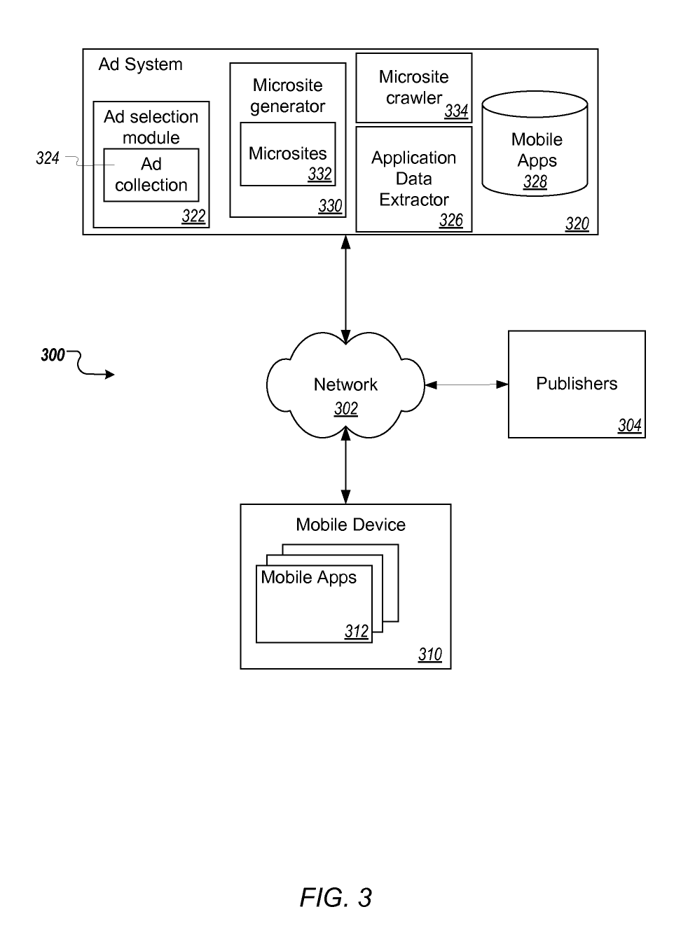

In some implementations, no context is provided with the mobile application or context information can be supplemented by context derived from a microsite model generated from the mobile application, as described in greater detail below with respect to FIGS. 3-6.

The following is an example of how an implementation as described above can be used. A developer can create the application 206 intended for the mobile device 204 using the software development kit 214. Particularly, the application 206 can be created according to the platform 218 and can include the object 216. The developer can forward the application 206 to the mobile device for use, for example when the device 204 is initially sold or as a later update, such as by a download process. The developer can also provide context relating to the application 206, such as by submitting one or more keywords and/or providing a version of the application 206, using the context sharing component 228. One or more context parameters can be registered at the advertisement distribution system 222.

When a user operates the mobile device 204, content such as one or more ads 212 can be presented on the page(s) 208. The content can be selected for presentation by the advertisement distribution system 222 based on the context parameter(s). In some implementations, the user can interact with the ad(s) 212 in one or more ways, such as by clicking on the ad 212, performing a developer-specified combination of key presses (e.g., tapping a single key twice, or tapping two keys in rapid succession), or tapping on the ad on a touchscreen device.

Content such as advertisements can be retrieved in any of a variety of ways. In some implementations, content can be retrieved essentially according to an on-demand approach. For example, ads or other content can be requested from the advertisement distribution system 222 and forwarded from there for display virtually immediately. Such implementations can have the advantage that the ad that is displayed to the user can be very current to the particular state of the application 206 and/or the mobile device 204.

In some implementations, a pre-fetch approach can be used. For example, a developer can configure the application 206 such that multiple content portions such as ads are requested from the advertisement distribution system 222. The ads can be stored at a suitable location, such as on the mobile device 204 and/or on another computer device such as a server that communicates with the mobile device 204. At some point, such as by determination performed by the application 206, the ad(s) can be displayed on the mobile device 204, for example when it returns to an online mode after having been offline. The developer can provide for reporting of which contents/ads have been displayed, for example by incorporating a feature from the software development kit 214 into the application 206. In some implementations, client-side frequency capping can be used, for example by having a class associated with content/ad presentation track previously served content/ads and ensure that the same content/ad is presented according to a rule (e.g., not more than a predetermined number of times per session). Other approaches for fetching content can be used.

In some implementations, a new content portion such as the ad 212 can be presented when an activity that uses the class associated with content/ad presentation is displayed for the first time. As another example, the new ad/content can be presented when the activity has been removed from an activity stack in the mobile device 204. In yet another example, a content/ad can be presented if a previous ad/content has been displayed for a predetermined amount of time if the mobile device 204 continues to be active (e.g., if a backlight of the display on the device remains on). In some implementations, the developer can facilitate user-initiated refresh of content/ads via a class responsible for generating gallery views, for example to provide a carousel-style browsing of ads.

The software development kit 214 has been mentioned in examples above. In some implementations, the kit 214 can be extended or enhanced using a wizard in an interface directed toward publishers. For example, the advertisement distributor system 222 can provide a user interface where publishers can establish an account to become affiliated with an advertising program, and this interface can feature the wizard as a way for the developer(s) to customize the look and feel of content/ads to be displayed in connection with the application 206. In some implementations, this can be implemented as a self-service sign-up process for developers, for example to allow the opportunity to enhance their application offering with ads and/or other content. As another example, and assuming that users' privacy rights are taken into account, such an interface can provide reporting statistics on ad clicks, impressions, queries, revenue and/or other aspects to the advertisement distributor system 222.

FIG. 3 shows an example system 300 for generating microsites and using the microsites to provide ads to mobile applications. The system 300 includes a mobile device 310 that is capable of installing, storing, and running a number of mobile applications 312. The mobile device 310 can be, for example, a smart phone, a personal digital assistant (PDA), or a mobile gaming device. In some alternative implementations, the functions performed by the mobile device 310 are not limited to mobile devices but can be performed by a personal computer, web enabled television, or other device.

The mobile device 310 communicates with one or more publishers 304 through a network 302 (e.g., the Internet, a cellular phone network, a LAN, or a WAN). The publishers 304 provide the mobile applications 312 to the mobile device 310 through the network 302. For example, a user of the mobile device 310 can use the mobile device 310 to access an application store associated with one or more of the publishers 304. The user can purchase one or more mobile applications through the application store. The purchased mobile applications are then provided to the mobile device 310 where they can be installed and stored by the mobile device 310 as some or all of the mobile applications 312. The user can then execute, or play, the mobile applications 312 using the mobile device 310.

In some implementations, one or more of the mobile applications 312 are configured to display ads to the user. For example, a mobile application displays ads in a particular location of a mobile application user interface, e.g., in the lower right corner of the screen, when the mobile application is executing on the mobile device 310. As another example, a mobile application displays ads during a start up page or in-between levels of a game having multiple levels.

The mobile applications 312 receive advertisements from an ad system 320 through the network 302. For example, a mobile application can include code that sets aside a portion of a page view of the mobile application as dedicated areas for displaying ads. The mobile application can further include code that, when executed, causes the mobile device 310 to send a request for one or more ads to the ad system 320. For example, when loading a page view, a mobile application can send an ad request to the ad system 320 for ads to be presented with that page view. Alternatively, when the mobile application is executed, one or more ads for presentation on page views of the mobile application can be pre-fetched from the ad system 320. The ad system 320 can identify advertisements to provide to the mobile device 310 in response to the request. The mobile application then presents the received ads to the user of the mobile device 310 in the designated areas of the page view.

The ad system 320 includes an ad selection module 322 for selecting ads to provide to the mobile device 310 in response to a request initiated by a mobile application. The ad selection module 322 includes an ad collection 324 which can be, for example, a database of ads that are available for selection by the ad selection module 322. For example, ads stored as part of the ad collection 324 can be ads provided to the ad system 320 by advertisers for distribution to end user devices, such as the mobile device 310. Upon receiving a request for an ad, the ad selection module 322 identifies ads from the ad collection 324 and provides the identified ads in response to the request.

In some implementations, the ad selection module 322 selects target ads that are relevant to the mobile application that initiated the ad request based on a context identified for the mobile application. For example, the available ads that make up the ad collection 324 can be associated with keywords to be used for targeting purposes. For example, an ad associated with keywords “car,” “race,” and “stockcar” can be identified as being relevant to a mobile application that relates to professional car racing.

In some implementations, mobile applications are associated with keywords to allow the ad selection module 322 to select ads from the ad collection 324 that are relevant to the mobile applications. For example, one of the publishers 304 provides a football based mobile application to the mobile device 310. The publisher associates keywords of “football” and “sports” with the mobile application. The ad selection module 322 can use the keywords associated with the mobile application by the publisher to identify ads that are relevant to football and sports. The identified ads can then be provided to the mobile device 310 in response to an ad request initiated by the mobile application.

In some implementations, context is not provided with the mobile application or there is low confidence in the provided context. For example, a mobile application may not be associated with keywords, or keywords that are associated with the mobile application are too generic for accurate ad targeting. Consequently, the ad system 320 can create a microsite for the mobile application to be used for identifying context for the mobile application to use in selecting targeted ads.

The ad system 320 includes an application data extractor 326 for extracting data from the mobile application including, for example, page views of the mobile application. In some implementations, the content can be extracted, for example, by a manual manipulation of the mobile application (not shown) or by an emulator that can be used to simulate the mobile application. In some implementations, the application data extractor 326 is part of the ad system 320, as shown in FIG. 2. In other implementations, the application data extractor 326 can be separate from the ad system 320 and provide extracted application data to the ad system 320.

In some implementations, the ad system 320 includes a database 328 of mobile applications. Mobile applications can be provided to the ad system 320 by the publishers 304 through the network 302 and stored in the database 328 by the ad system 320.

In some implementations, the application data extractor 326 can access the mobile applications in the database 328. The application data extractor 326 can be used to retrieve content from the mobile applications and used, for example, to build a graph associating page views or screenshots of the mobile application content.

In some alternative implementations, the ad system 320 receives page views of the mobile application from the mobile device 310. In such implementations, the ad system 320 need not include a local storage of mobile applications. In some implementations, the ad system 320 includes a database for storing screenshots of page views of a mobile application. For example, the ad system 320 can receive screenshots of the mobile application from the mobile device 310 through the network 302 and store the screenshots locally in a database. The extracted content from the mobile application is organized to create a directed graph that represents a flow of a mobile application. In some implementations where the application data extractor 326 is separate from the ad system 320, the application data extractor 326 can provide extracted application data to the ad system 320 for use in constructing the directed graph. In other implementations, the application data extractor can construct the directed graph.

Page views of the mobile application are represented by nodes of the directed graph. Generating the directed graph can include creating a first node for a start page of the mobile application. The first node associated with the start page can then be annotated with information that is relevant to the start page. For example, the application data extractor 326 can generate a screenshot of the start page and include the screenshot as an annotation for the first node associated with the start page.

In some implementations, the application data extractor 326 includes optical character recognition (OCR) functionality for identifying text in the screenshot of the start page. The application data extractor 326 can extract text from the screenshot using the OCR functionality and annotate the first node with the text. In some implementations, the application data extractor 326 recognizes additional features present in the start page from the screenshot and annotates the first node with these additional features.

For example, the application data extractor 326 can identify images within the screenshot and annotate the first node with the images. As another example, the application data extractor 326 can identify the names of objects depicted in the screenshot and annotate the first node with the name of the object. Following this example, the application data extractor 326 can identify an image of a flower included in the start page as being a flower, and annotate the first node with the word “flower” (e.g., using a system that associates image content with an annotated repository of images, for example, an image search system).

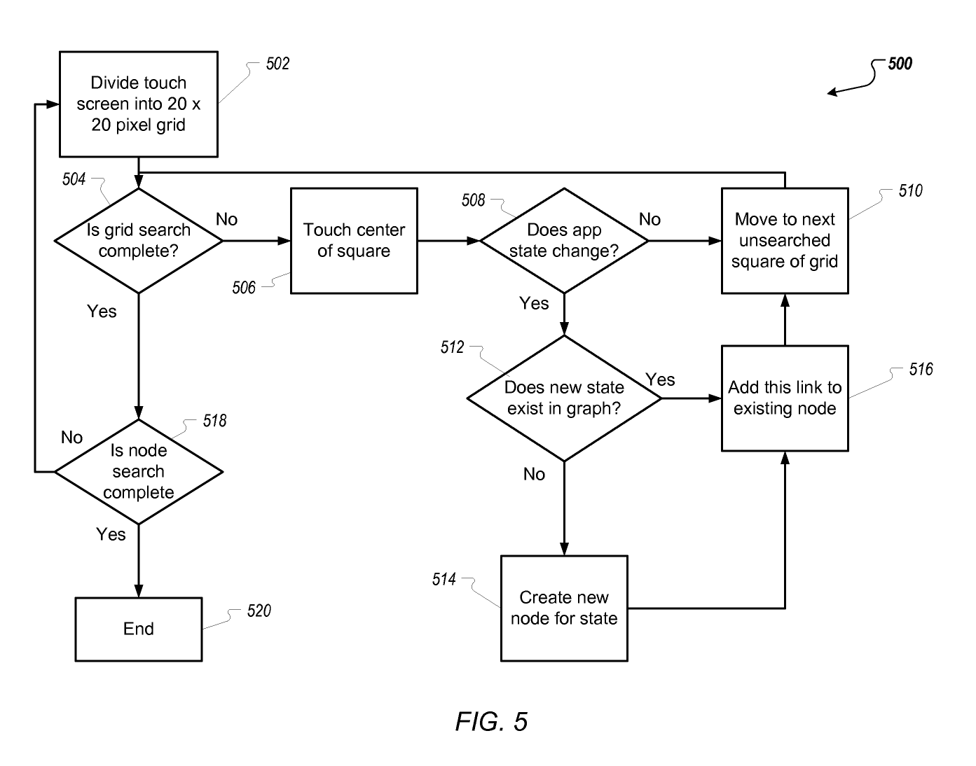

The application data extractor 326 creates additional nodes for the directed graph by conducting a breadth-first search of page views of the mobile application. The application data extractor 326 can identify page views that are linked to by the start page by entering all possible inputs for the start page. For example, the application data extractor 326 can select each button present on the start page one at a time to identify page views that each button links to. As another example, the application data extractor 326 can select each possible value from a drop down menu to identify page views that are presented in response to each selection. As yet another example, the application data extractor 326 can enter text into a text field to identify page views that are linked to by the start page. An example of manually interacting with the application to extract content is described below with respect to FIG. 5.

The application data extractor 326 can create a node in the directed graph for each identified page view. The application data extractor 326 can link the newly created nodes to the first node with directed links. The direction of the directed links can point from the first node to the newly created nodes to indicate that the newly created nodes are associated with page views that can be reached directly from the start page (e.g., page views that are one step away from the start page within the flow of the mobile application).

The application data extractor 326 can annotate each of the newly created nodes with information relevant to the page view associated with the corresponding node as described above for the first node. For example, the application data extractor 326 can annotate a newly created node with a screenshot of an associated page view and text derived from the screenshot using OCR functionality or image identification functionality.

In some implementations, the application data extractor 326 also annotates the links between nodes of the directed graph. For example, the application data extractor 326 can annotate a directed link with an action that caused the mobile application to transition from a first page view associated with a node at the beginning of the directed link to a second page view associated with a node at the destination of the directed link. An annotation can indicate, for example, that a particular icon or portion of text was selected to cause the transition from the first page view to the second page view. As another example, an annotation can indicate that a particular value was selected from a drop down menu to cause the transition from the first page view to the second page view.

The application data extractor 326 can continue the breadth-first search of page views of the mobile application by identifying page views that are linked to by each subsequently identified page view. The application data extractor 326 can enter possible inputs, as described above, for each subsequently identified page view in order to identify additional page views of the mobile application. For example, the application data extractor 326 can select each button present on a page view one at a time to identify page views that each button links to.

In some implementations, upon obtaining a screenshot of a new page view, the application data extractor 326 can compare the screenshot of the new page view to previously captured screenshots of page views for the mobile application to determine if the new page view has already been identified. If a match is discovered between the newly obtained screenshot and a previously obtained screenshot, the application data extractor 326 can determine that a cycle has occurred.

The application data extractor 326 can create a directed link that leads from the node associated with a page view that proceeded the new page view to a node associated with the previously obtained screenshot. In such instances, the application data extractor 326 can determine that page views that are linked to by the new page view have already been identified, and therefore, a breadth-first search starting from the new page view is not necessary.

In some implementations, the application data extractor 326 ends the breadth-first search when all pending page view explorations have resulted in cycles, or page views with no outgoing links. In some implementations, the application data extractor 326 ends the breadth-first search after a predetermined nodes in the directed graph have been created. In some implementations, the application data extractor 326 ends the breadth-first search after a predetermined search depth has been reached. For example, the application data extractor 326 can end the breadth-first search after all page views that are six steps from the start page have been identified.

In some implementations, the directed graph includes a designated start node. For example, the node associated with the start page of the mobile application can be designated as the start node. In some implementations, the directed graph includes a designated end node.

In some implementations, the application data extractor 326 can determine that the breadth-first search of the mobile application was unsuccessful. For example, the directed graph may contain too few nodes to be useful for the purposes of selecting advertisements. In such implementations, the application data extractor 326 can provide an indication to an administrator of the ad system 320 that the search for the mobile application was unsuccessful.

The ad system 320 includes a microsite generator 330 for creating microsites from directed graphs generated by the application data extractor 326. The microsites generated by the microsite generator 330 are used to identify advertisements that are relevant to a particular mobile application. The microsite generator 330 constructs a microsite for a mobile application by converting each node of a directed graph for the mobile application into a page of the microsite. For example, the microsite generator 330 can create the microsite as a website where each page of the microsite is a webpage. The microsite generator 330 can, for example, use code such as HTML, Javascript, or Python, to create the pages.

The microsite generator 330 can populate a page associated with a node with some or all of the annotations for the node. For example, the microsite generator can populate each page with the extracted text of the corresponding mobile application page view (e.g., from the OCR process). Alternatively, the microsite generator 330 can populate the page with text associated with the node as well as a screenshot of the mobile application page view associated with the node and images extracted from the screenshot. In some implementations, the microsite generator 330 can represent each outgoing link for the node by including a link (e.g., a hyperlink) on the page. The microsite generator 330 can use a text annotation of a directed graph link as text to associate with a link included as part of the page. The links inserted into the page link to other pages of the microsite that are associated with destination nodes of the respective directed graph links. In some applications, the microsite generator 330 can designate a page associated with the start node of a directed graph as a start page for the microsite.

In some implementations, the microsite generator 330 will generate a microsite for a mobile application after the application data extractor 326 has completed building a directed graph for the mobile application. In other implementations, the microsite generator 330 can begin converting a directed graph into a microsite while the application data extractor 326 is still searching through the pages of the mobile application and creating nodes and links within the directed graph.

The microsite generator 330 can include a store of microsites 332. For example, after the microsite generator 330 has completed building a microsite for a mobile application, the microsite generator 330 stores the microsite in the store of microsites 332. When ad system 320 receives a request for ad content initiated by a mobile application, the ad system 320 can access the store of microsites 332 to determine if a microsite for the mobile application already exists. In some implementations, if a microsite for the mobile application is identified in the store of microsites 332, a search of the mobile application need not be performed and the identified microsite can be used to identify context for targeting ads to the mobile application.

In some implementations, the ad system 320 includes a microsite crawler 334 for crawling microsites and extracting keywords from the microsites. In some implementations, the microsite crawler 334 can be a web crawler that is also capable of crawling websites in order to extract keywords from webpages of the website. In other implementations, the microsite crawler 334 can be a stand alone application that is dedicated to performing microsite crawling functions.

In some implementations, the microsite crawler 334 accesses the store of microsites 332 in order to obtain a microsite for a mobile application. In other implementations, the microsite generator 330 can provide a microsite associated with a mobile application to the microsite crawler 334. The microsite crawler 334 can parse through the pages of the microsite to identify keywords to associate with the mobile application for the purposes of ad targeting.

In some implementations, the microsite crawler 334 starts by parsing text of a start page of a microsite to extract keywords. The microsite crawler 334 can use links of the start page to access other pages of the microsite. The microsite crawler 334 can continue to parse pages and follow links in this fashion until the microsite crawler 334 has crawled the entire microsite, or until the microsite crawler 334 has extracted enough useful information in order to accurately associate keywords with a mobile application associated with the microsite.

In some implementations, the microsite crawler 334 can rank keywords with respect to one another in order to identify certain keywords as being more relevant to a mobile application than other keywords. For example, keywords that are found more often through out the microsite can be given a higher rank. As another example, keywords that are found on pages having a high indegree (aka, a high number of pages that link to them) can be given a higher rank.

The microsite crawler 334 can associate keywords identified using a microsite with the mobile application corresponding to the microsite. The ad selection module 322 can use the keywords identified by the microsite crawler 334 to select ads to provide to the mobile device in response to a request for ads initiated by the mobile application. For example, the microsite crawler 334 can identify keywords of “fashion,” “clothing,” and “models” and associate the keywords with a mobile application. The ad selection module 322 can then identify ads from the ad collection 324 that are associated with keywords of “fashion,” “clothing,” and “models.” The ad system 320 then provides the identified ads to the mobile device 310 for display as part of a page view of the mobile application.

In some alternative implementations, the microsite crawler can identify keywords for each page of an application. Requests for ads received from the mobile device 310 can include page identifiers (e.g., channel ids) for one or more pages that are to display the requested ads. The ad selection module can then identify keywords from the corresponding microsite pages and use them for ad targeting.

The functions performed by the components of the ad system 320 can be performed by a single system, or by a collection of systems. In some implementations, the ad system 320 may include more or less components than depicted in FIG. 3. For example, the ad system 320 can additionally include a look-up table for storing indicators of mobile applications and associated keywords for the mobile applications. The look-up table can be populated by the microsite crawler 334 and the ad selection module 322 can use the look-up table to identify keywords associated with a mobile application when the ad system 320 receives a request for ads initiated by the mobile application.

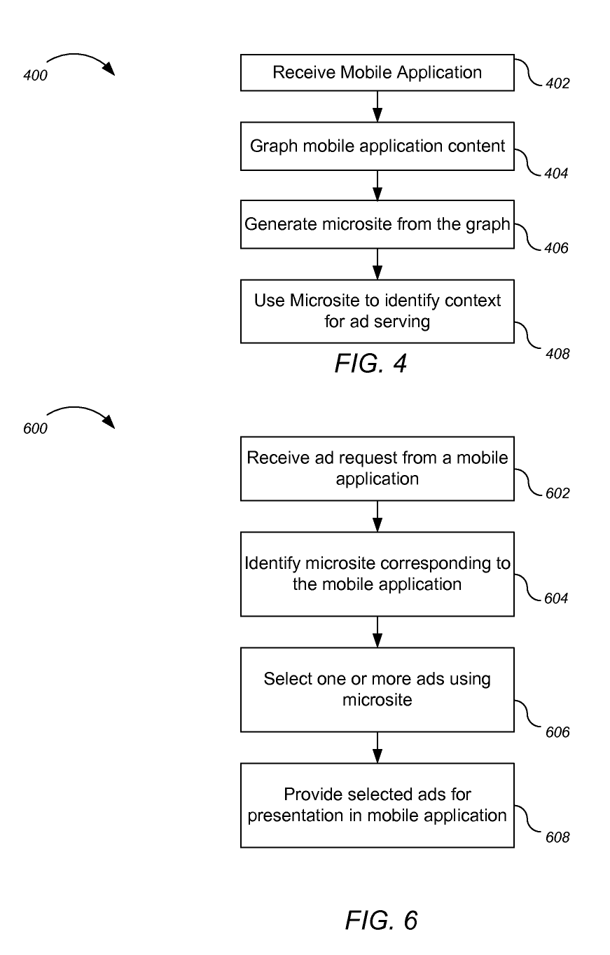

FIG. 4 shows a flow chart of an example process 400 for generating a microsite model. In some implementations, the process 400 can be performed by a system such as the ad system 320 shown in FIG. 3 or the advertising management system 104 shown in FIG. 1.

At step 402, a mobile application is received. For example, an ad system (e.g., the ad system 320 of FIG. 3) can receive the mobile application from a publisher. As another example, the ad system can receive the mobile application from a mobile device (e.g., the mobile device 310 of FIG. 3) that is capable of executing the mobile application. In some implementations, the mobile application can be received over a network, such as the Internet. In some implementations, the received mobile application is stored in a database of mobile applications (e.g., the database 328 of FIG. 3).

At step 404 mobile application content is graphed. For example, a directed graph of content of the mobile application can be generated from extracted mobile application content. The directed graph can be created from page views of the mobile application with each node of the directed graph representing a unique page view of the mobile application and links of the directed graph representing relationships between the page views. For example, a link that leads from a first node to a second node can indicate that a page view associated with the first node can lead to a page view associated with the second node when one or more actions are performed (e.g., selecting an icon).

The nodes of the directed graph can be annotated with features derived from their associated page views. For example, a screen shot can be taken of a page view of the mobile application. Text recognition software can be used to identify text in the screen shot. A node in the directed graph that is associated with the page view can be annotated with the text derived from the screen shot as well as an image of the screen shot. In some implementations, additional features of a page view are identified using the screen shot. For example, images displayed within the page view can be identified and added as annotations to the associated node.

Links of the directed graph can be annotated with actions that are performed in order to cause the mobile application to move from a first page view associated with a node at the beginning of the link to a second page view associated with a destination node of the link. For example, a link can be annotated with “select icon at (x,y)” where x and y are coordinates on a page view, in order to indicate that a transition in page views occurs when an icon at the given coordinates is selected. As another example, a link can be annotated with “select option ‘expert’” to indicate that a transition in page views occurs when the option “expert” is selected from a drop down menu.

In some implementations, the page views of the mobile application are identified using a breadth-first search. For example, a first node can be created in the directed graph for the starting page view of the mobile application. Each possible input for the starting page view is then entered in order to cause the mobile application to display additional page views. For example, every selectable icon on the starting page view is selected and text is entered into text fields of the starting page view. Nodes are created in the directed graph for the additional page views and directional links are created leading from the first node associated with the starting page view to the nodes associated with the additional page views.

This process of selecting each possibly input for a page view is repeated for newly identified page views until a predetermined depth has been reached, a predetermined number of nodes have been created, and/or all page views of an application have been discovered. In some implementations, cycles within the flow of the mobile application are identified. This can be accomplished by comparing a screen shot of a page view with previously obtained screen shots for the mobile application to determine if the page view has already been identified. If a new screen shot matches a previously obtained screen shot, a directed link is created that lead from a node associated with a page that proceeded that page view associated with the new screen shot, to a node associated with the previously obtained screen shot. In some implementations, the breadth-first search of the mobile application is halted when all pending page views lead to cycles or dead ends (e.g., a page view with no out going links).

At step 406, a microsite is generated from the graph. For example, a microsite generator (e.g., the microsite generator 330 of FIG. 3) crawls the graph and creates a page for each node of the graph. In some implementations, the microsite is a website and the pages are web pages. The pages of the microsite can be populated with the annotations associated with each node. For example, each page of the microsite can include the text identified from the associated page views. In another example, a page of the microsite can include text annotations of an associated node as well as an image of an associated page view of the mobile application. As another example, the page can include images that are included as annotations for the associated node.

In some implementations, links of the directed graph are represented as links (e.g., hyper links) on the pages of the microsite. For example, a link can be added to a microsite page that is associated with a node from which a link of the directed graph originates. Text associated with the microsite page link can be derived from annotations of the directed graph link. For example, if the directed graph link is annotated with the text “select option ‘expert’” the text “select option ‘expert’” can be placed on the microsite page associated with the node from which a link of the directed graph originates. The text can be a link to a second page that is associated with a destination node of the directed graph link. This ensures that the pages of the microsite are linked together with other pages of the microsite in the same flow as the associated nodes of the directed graph.

At step 408, the microsite is used to identify context for ad serving. For example, a microsite crawler (e.g. the microsite crawler 334 of FIG. 3) can be used to crawl the microsite and extract keywords from the pages of the microsite. Keywords can be identified from the crawled text according to particular criteria (e.g., number of occurrences within the microsite). These keywords can then be used to identify relevant ads. In some implementations, the microsite crawler is a web crawler that is also capable of crawling websites and identifying keywords in webpages of the websites.

The microsite crawler can start by parsing a starting page of the microsite (e.g., a page associated with a starting page view of the mobile application). The microsite crawler can extract keywords from the starting page and then follow links included in the starting page to access other pages of the microsite. The microsite crawler can then extract keywords from those pages and follow links included in those pages. The microsite crawler can continue to follow links of the microsite until all pages of the microsite have been crawled, or until a sufficient amount of data has been collected to identify keywords for the microsite.

In some implementations, the identified keywords are associated with the mobile application. For example, an indicator of the mobile application can be entered into a database and keywords extracted from the microsite can be associated with the indicator in the database. The keywords can be used to identify ads that are relevant to the mobile application. For example, an ad selector (e.g. the ad selection module 322 of FIG. 3) can use the keywords associated with a mobile application to identify relevant ads from a collection of available ads (e.g. ad collection 324 of FIG. 3).

In some implementations, available ads will also be associated with keywords. The ad selector can identify ads having the same or similar keywords as being relevant to the mobile application. Some or all of the identified ads can be supplied in response to a request for ads initiated by the mobile application and displayed as part of a page view of the mobile application. In some implementations, keywords can be associated with each page of the mobile application, and advertisements can be identified for each page of the mobile application. In such implementations, a request for ads can include page identifiers (e.g., a particular channel ID for the particular page of the mobile application) to identify one or more pages on which the requested ads will be displayed.

In some implementations of the process 400, more or fewer steps can be performed or one or more steps can be performed in a different order. For example, the process 400 may additionally include a step of supplying one or more identified ads to a mobile device. As another example, the process 400 may additionally include a step of receiving screen shots of page views of the mobile application in place of the step of receiving the mobile application.

FIG. 5 shows a flow chart of an example process 500 or systematically obtaining pages from a mobile application. In some implementations, the process 500 is performed by a system such as the ad system 320 shown in FIG. 3 or the advertising management system 104 shown in FIG. 1. The process 500 can be used to identify page views of the mobile application.

At step 502, a touch screen is divided into 20×20 pixel grids. For example, a page view of the mobile application is divided into a grid where each square of the grid is 20×20 pixels. Dividing the touch screen into a grid allows each page of the mobile application to be systematically explored a grid at a time.

At step 504, it is determined if the grid search is complete. This can be determined by keeping track of which grid portions of the page view have been searched. If not all grid portions of the page view have been searched, it is determined that the grid search for the current page view is not complete. If it is determined that the grid search is not complete, the process 500 proceeds to step 506.

At step 506, a center of a current square of the screen is touched. For example, the center of the current 20×20 pixel square is selected. In some implementations, an action is performed to cause the center of the square to be selected as if being clicked on by a mouse, or being selected by a finger or stylus using a touch screen of a device. The action is performed to determine if the current 20×20 pixel square is selectable.

At step 508, it is determined if the application state changes. For example, a different page view may be displayed in response to the selection that occurred at step 506. As another example, an aspect of the current page view may change (e.g., color of text changes, or an icon appears) in response to the selection that occurred at step 506. If it is determined that the application state does not change, the process 500 proceeds to step 510.

At step 510, the process 500 moves to the next unsearched square of the grid. For example, if the current 20×20 pixel square is the upper left square of the page view, the process 500 can move to the 20×20 pixel square immediately to the right of the current square. This function allows the process 500 to step through the squares of a page view one at a time.

If it is determined at step 508 that the application state does change in response to the selection at step 506, the process 500 proceeds to step 512. At step 512, it is determined if the new state already exists in a directed graph that is being generated for the mobile application. For example, a screen shot of the new state of the mobile application can be compared to screen shots obtained for previous states of the mobile application to determine if a node already exists for the new state of the mobile application. If the screen shot of the new state matches a previously obtained screen shot, it can be determined that the new state is already represented in the graph. If the screen shot of the new state does not match any previously obtained screen shots, it can be determined that the new state of the mobile application is not represented in the graph. If it is determined that the new state is not represented in the graph, the process 500 proceeds to step 514.

At step 514 a new node is created for the new state of the mobile application. In some implementations, the node is annotated with information associated with the new state. For example, the node can be annotated with a screen shot of the new state. As another example, text recognition software can be used to identify text in a screen shot of the new state and the identified text can be used to annotate the node. In some alternative embodiments, text can be extracted from a collected set of screen shots and used to annotate the node. After step 514 is performed, or if at step 512 it is determined that the new state already exists in the graph, the process 500 proceeds to step 516.

At step 516, a link is added to the existing node in the graph. For example, a directed link is added to the graph that originates at a previous state for the mobile application and terminates at the node associated with the new state (e.g., either the newly added node added at step 514, or the previously added node identified at step 512). In some implementations, the link is annotated with an action that caused the mobile application to transition from the previous state to the new state. After adding the new link to the graph, step 510 of moving to the next unsearched square of the grid is performed.

After step 510, the process 500 returns to step 504 of determining if the grid search is complete. If it is determined that the grid search is not complete, the step 506 is repeated for the new unsearched square of the grid. If it is determined that the grid search is complete, the process 500 proceeds to step 518. At step 518, it is determined if the node search is complete. In some implementations, it can be determined that the node search is complete if all nodes of the graph are part of an identified cycle, or are dead ends (e.g., no outgoing links).

In some other implementations, it can be determined that the node search is complete if the page views of the mobile application have been searched to a predetermined depth (e.g., all pages 7 steps away from a starting page have been identified). In still other implementations, it can be determined that the node search is complete if the number of nodes in the graph is equal to or greater than a predetermined number of nodes.

If it is determined that the node search is not complete, the process 500 moves to the next page view and proceeds to step 502 for the next page view. If it is determined that the node search is complete, the process 500 ends at step 520.

FIG. 6 shows a flow chart of an example process 600 or serving ads to a mobile application. In some implementations, the process 600 is performed by a system such as the ad system 320 shown in FIG. 3 or the advertising management system 104 shown in FIG. 1.

At step 602, an ad request is received from a mobile application. For example an ad server (e.g., the advertisement distributor system 222 of FIG. 2) can receive a request for advertising content that is initiated by mobile application (e.g., the application 206 of FIG. 2) running on a mobile device (e.g., the mobile device 204 of FIG. 2). As another example, a system may be executing a mobile application and then receive a request for an ad from the mobile application.

At step 604, a microsite corresponding to the mobile application is identified. For example, the ad server can access a database of microsites (e.g., the store of microsites 332) that have been created for various mobile applications. In some implementations, the ad server can receive an identifier for the mobile application along with the ad request. The ad server can use the identifier to identify a microsite associated with the mobile application. The microsite can be a collection of pages that represent page views of the mobile application (e.g., generated as described above with respect to FIGS. 4-5). The pages of the microsite can be linked together to represent a program flow of the mobile application.

In some implementations, the microsite is created by a microsite generator (e.g., the microsite generator 330 of FIG. 3). The microsite can be created from a directed graph having nodes that represent page views of the mobile application and directed links representing transitions that occur between page views of the mobile application. The pages of the microsite can be populated with information derived from page views of the mobile application. For example, screen shots of the page views, text extracted from the screen shots, images extracted from the page views, and actions that can be performed on the page views can be used to populate the pages of the microsite.

At step 606, one or more ads are selected using the microsite. For example, the identified microsite can be used to identify keywords associated with the mobile application. The keywords can then be compared to keywords associated with available ads to identify one or more ads that can be provided in response to the request received at step 602. In some implementations, a page crawler (e.g., the microsite crawler 334 of FIG. 3) is used to crawl the pages of the microsite and extract keywords from the pages of the microsite. In some implementations, the page crawler can be a web crawler configured to crawl websites and extract keywords from webpages of the websites. In some implementations, the keywords are stored in a database of keyword for later use. For example, if a request for ads associated with the same mobile application is received in the future, the stored keywords and be accessed and used to identify relevant advertisements.

In some implementations, the page crawler applies ranking values to extracted keywords based on the number of times the keyword appear on pages of the microsite and based on the indegree of pages which contain the keywords. For example, a keyword that is found on a page having a high indegree (aka, a high number of pages that link to the page) can be given a higher ranking value than other keywords that are found on pages having lower indegrees. The keywords having the highest ranking values can be identified as the most relevant keywords. The most relevant keywords can then be used to identify ads that are relevant to the mobile application.

At step 608, selected ads are provided for presentation in the mobile application. For example, the ad server (e.g., the ad system 320 of FIG. 3) can provide the selected ads to the mobile device (e.g., the mobile device 310 of FIG. 3) for presentation to a user of the mobile device as part of a page view of the mobile application. For example, a page view of the mobile application may include designated areas for displaying the provided ads. Alternatively, in some implementations, the selected ads are provided to a content provider associated with the mobile application for incorporating ads into content that is then provided to the mobile application for display. In some implementations, the mobile device stores one or more ads provided by the ad server for later use. The stored ads can be displayed as part of future page views of the mobile application.

In some implementations of the process 600, more or fewer steps can be performed or one or more steps can be performed in a different order.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. The computer storage medium can be, or be included in, a computer-readable storage device, a computer-readable storage substrate, a random or serial access memory array or device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
generating a directed graph of a mobile application, each node of the directed graph corresponding to an annotated page view of the mobile application;
converting, using one or more processors, the directed graph into a microsite of the mobile application;
crawling the microsite to identify keywords for the mobile application; and
using the identified keywords to identify candidate advertisements to present to users of the mobile application.

2. The method of claim 1, where generating the directed graph further comprises:
generating a screenshot for each page view of the mobile application;
extracting text from each screenshot; and
using the extracted text to annotate the page view.

3. The method of claim 2, where generating screenshots comprises:
initiating the mobile application;
capturing a screenshot of the starting page of the mobile application;
systematically providing input to the mobile application to identify possible responses from the mobile application; and
generating a separate screenshot for each response from the mobile application.

4. The method of claim 1, where converting the directed graph into a microsite further comprises:
converting each node of the graph into a page of the microsite; and
converting each edge of the graph into a link to a related page of the microsite.

5. The method of claim 1, where the extracted keywords are assigned a weight according to a relative importance of the page view in the mobile application.

6. The method of claim 5, where the relative importance is determined based on the number of directed edges in the graph pointing to the node corresponding to the page view.

7. The method of claim 1, where generating the directed graph includes obtaining a channel ID for each page view and including the channel ID in the annotation for the page view.

8. A method comprising:
receiving a request for an ad, the request including an application identifier;
using the application identifier to identify, using one or more processors, a corresponding microsite;
using keywords generated for the microsite to identify candidate ads;
selecting one or more ads of the candidate ads; and
providing the selected ads for presentation by the mobile application.

9. The method of claim 8, where selecting one or more ads includes:
ranking the candidate ads according to a score, the score depending on a weight given to particular keywords extracted from the microsite.

10. The method of claim 8, where receiving the request includes receiving a channel ID associated with the page view of the mobile application to present the requested ad, the method further comprising:
identifying the particular portion of the microsite associated with the received channel ID; and
using the keywords from the particular portion to identify the candidate ads.

11. A system comprising:
one or more processors configured to interact with a computer-readable medium in order to perform operations comprising:
generating a directed graph of a mobile application, each node of the directed graph corresponding to an annotated page view of the mobile application;
converting the directed graph into a microsite of the mobile application;
crawling the microsite to identify keywords for the mobile application; and
using the identified keywords to identify candidate advertisements to present to users of the mobile application.

12. The system of claim 11, where generating the directed graph further comprises:
generating a screenshot for each page view of the mobile application;
extracting text from each screenshot; and
using the extracted text to annotate the page view.

13. The system of claim 12, where generating screenshots comprises:
initiating the mobile application;
capturing a screenshot of the starting page of the mobile application;
systematically providing input to the mobile application to identify possible responses from the mobile application; and
generating a separate screenshot for each response from the mobile application.

14. The system of claim 11, where converting the directed graph into a microsite further comprises:
converting each node of the graph into a page of the microsite; and
converting each edge of the graph into a link to a related page of the microsite.

15. The system of claim 11, where the extracted keywords are assigned a weight according to a relative importance of the page view in the mobile application.

16. The system of claim 15, where the relative importance is determined based on the number of directed edges in the graph pointing to the node corresponding to the page view.

17. The system of claim 11, where generating the directed graph includes obtaining a channel ID for each page view and including the channel ID in the annotation for the page view.

18. A system comprising:
one or more processors configured to interact with a computer-readable medium in order to perform operations comprising:
receiving a request for an ad, the request including an application identifier;
using the application identifier to identify a corresponding microsite;
using keywords generated for the microsite to identify candidate ads;
selecting one or more ads of the candidate ads; and
providing the selected ads for presentation by the mobile application.

19. The system of claim 18, where selecting one or more ads includes:
ranking the candidate ads according to a score, the score depending on a weight given to particular keywords extracted from the microsite.

20. The system of claim 18, where receiving the request includes receiving a channel ID associated with the page view of the mobile application to present the requested ad, the method further comprising:
identifying the particular portion of the microsite associated with the received channel ID; and
using the keywords from the particular portion to identify the candidate ads.

21. A computer storage medium encoded with a computer program, the program comprising instructions that when executed by data processing apparatus cause the data processing apparatus to perform operations comprising:
generating a directed graph of a mobile application, each node of the directed graph corresponding to an annotated page view of the mobile application;
converting the directed graph into a microsite of the mobile application;
crawling the microsite to identify keywords for the mobile application; and
using the identified keywords to identify candidate advertisements to present to users of the mobile application.

22. A computer storage medium encoded with a computer program, the program comprising instructions that when executed by data processing apparatus cause the data processing apparatus to perform operations comprising:
receiving a request for an ad, the request including an application identifier;
using the application identifier to identify a corresponding microsite;
using keywords generated for the microsite to identify candidate ads;
selecting one or more ads of the candidate ads; and
providing the selected ads for presentation by the mobile application.
